(19) United States
(12) Patent Application Publication
(10) Pub. No.: US 2014/0351857 A1
(43) Pub. Date: Nov. 27, 2014

(54) Method, Electronic Program Menu and Processing Device for Displaying Television Program Related Information

(71) Applicants: Chao Liu, Qingdao City (CN); Mingang Wang, Qingdao City (CN); Fen Liu, Qingdao City (CN); Guangfeng Zhang, Qingdao City (CN); Tao Gao, Qingdao City (CN)

(72) Inventors: Chao Liu, Qingdao City (CN); Mingang Wang, Qingdao City (CN); Fen Liu, Qingdao City (CN); Guangfeng Zhang, Qingdao City (CN); Tao Gao, Qingdao City (CN)

(73) Assignees: QING DAO HAIER ELECTRONIC CO., LTD., Qingdao City, Shandong Province (CN); HAIER GROUP CO., LTD., Qingdao City, Shandong Province (CN)

(21) Appl. No.: 13/813,159

(22) PCT Filed: Dec. 3, 2010
(86) PCT No.: PCT/CN10/79441

§ 371 Date: Jul. 20, 2014

(51) Int. Cl. H04N 21/431; G06F 3/0482; H04N 5/445; G06F 3/0481

(52) U.S. Cl. CPC H04N 21/4316; G06F 3/04817; G06F 3/0482; H04N 5/44543; H04N 21/4314; H04N 2005/44556
USPC 725/40

(57) ABSTRACT

The present invention relates to a method for displaying information associated with television program, which includes: fetching a plurality of sequentially arranged program listings and corresponding program notes; generating an electronic program guide according to the program listings and corresponding program notes; and displaying the electronic program guide. The electronic program guide includes a program listing, a program note associated with the program listing, and at least one icon indicating that the user would select to display the previous or the next program listing in the electronic program guide. The present invention further provides an electronic program guide and a processing apparatus for generating the electronic program guide. The electronic program guide can display information associated with TV program in a more intuitive manner.

### FIELD OF THE INVENTION

The present invention relates generally to digital television technology, and more particularly to a method for displaying information associated with television programs, an electronic program guide generated by the method, and a process apparatus for generating the electronic program guide.

### BACKGROUND OF THE INVENTION

Digital television (DTV) technology is the transmission of audio and video by digitally processed and multiplexed signal. In contrast to the conventional analog television transmitted via cables, digital television has advantages such as low signal loss, better image and voice quality, and thus is preferred by users. Furthermore, except the television signal, digital television is capable of transmitting additional information such as television program list for each channel, real time weather forecast, and even the digital television network can be used to surf internet. To ensure that the users can use the various functions provided by digital television conveniently, it is crucial to provide a user-friendly and intuitive user interface. Thus, in the known digital television systems, electronic program guide is provided for the users to use the various functions provided by digital television systems.

For example, in a program list of a channel, the known manner is listing the programs within a certain time period in the time order. The users could select a specific program to browse further information associated with the selected program. Because the program list occupies a lot of space itself, there is only limited space left to display the further information.

### SUMMARY OF THE INVENTION

To solve the aforementioned problem, an aspect of the present disclosure is to provide a more intuitive method for displaying information associated with television program.

Another aspect of the present disclosure is to provide an electronic program guide that is capable of displaying information associated with television program in a more intuitive manner.

Still another aspect of the present disclosure is to provide a process apparatus for displaying information associated with television program in a more intuitive manner.

The above aspects of the present disclosure are achieved by the following technical solutions:

One embodiment of the present disclosure provides a method for displaying information associated with television program, which includes: fetching a plurality of sequentially arranged program listings and corresponding program notes; generating an electronic program guide according to the program listings and corresponding program notes; and displaying the electronic program guide. The electronic program guide includes a program listing, a program note associated with the program listing, and at least one icon indicating that the user would select to display the previous or the next program listing in the electronic program guide.

In another embodiment, the at least one icon includes a first icon and a second icon for indicating that the user would select to display the previous and the next program listing in the electronic program guide, respectively.

In another embodiment, the method further includes changing the status of the first icon when the program listing is the first one, and changing the status of the second icon when the program listing is the last one.

In another embodiment, the aforementioned changing the status of the first icon or the second icon includes setting the first icon or the second icon into invisible.

In another embodiment, the icon includes texts or images.

In another embodiment, the method further includes receiving inputting from user and displaying a previous or a next program listing and a related program note.

In another embodiment, the aforementioned displaying a previous or a next program listing further includes changing the status of a corresponding icon of the at least one icon in a predetermined period.

In another embodiment, the plurality of program listings is arranged in the order of broadcast time.

In another embodiment, the program listing is displayed above the program note.

In another embodiment, the electronic program guide further includes a background area, and the program listing and the program note are displayed on the background area.

In another embodiment, the background area is fully opaque.

Another embodiment of the present disclosure provides an electronic program guide, which includes a program listing, a program note associated with the program listing, and at least one at least one icon indicating that the user would select to display the previous or the next program listing in the electronic program guide.

Another embodiment of the present disclosure provides a process apparatus, which includes: an information fetching module, configured for fetching a plurality of sequentially arranged program listings and corresponding program notes; an electronic program guide generating module, configured for generating an electronic program guide according to the program listings and corresponding program notes; and a displaying module, configured for displaying the electronic program guide. The electronic program guide includes a program listing, a program note associated with the program listing, and at least one icon indicating that the user would select to display the previous or the next program listing in the electronic program guide.

In another embodiment, the processing apparatus further includes a program selecting module, configured for changing the program listing displayed in the electronic program guide and switching the program note in the electronic program guide according to the displayed program listing.

In the above described method and apparatus for displaying information associated with television program, only one program listing is displayed for each time, the program listing occupies only a little space and most of the space is available for displaying the program note. Thus, more association information can be displayed, and the switching of different programs can be achieved by the navigation keys. The method and the apparatus have the advantages of intuitive, simple, and straightforward.

To make above and other objects, features, and advantages be more apparent, the present disclosure is described in detail with preferred embodiments and the accompanying drawings as follows.

### BRIEF DESCRIPTION OF THE DRAWINGS

FIG. 1 is a block diagram of a digital television playing system provided by an embodiment of the present disclosure.

FIG. 2 is a flow chart of a method for displaying information associated with television program according to an embodiment of the present disclosure.

FIG. 3 is a schematic view showing an architectural rendering of an electronic program guide displayed in a screen according to the method of FIG. 2.

### DETAILED DESCRIPTION OF PREFERRED EMBODIMENTS

To further elaborate the technical means employed by the present invention to achieve the above objectives and the advantages, a method for displaying information associated with television program, an electronic program guide, and a processing apparatus provided by the present disclosure is described in detail with preferred embodiments and the accompanying drawings as follows.

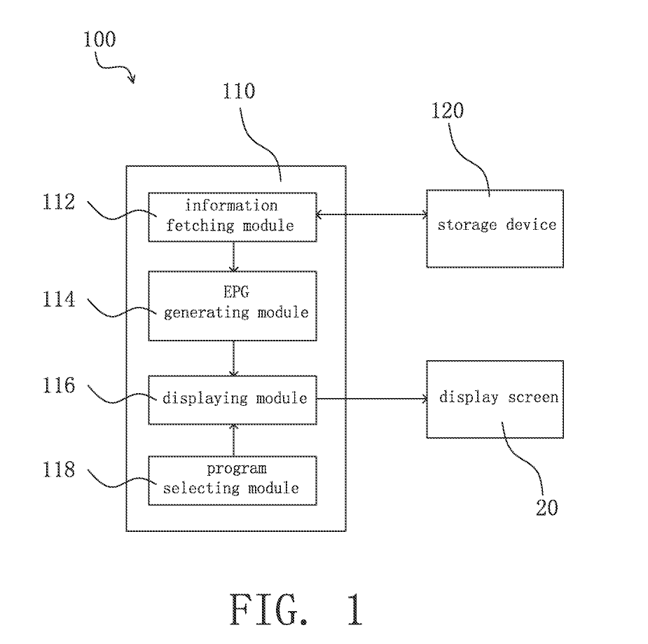

FIG. 1 is a block diagram of a digital television playing system provided by an embodiment of the present disclosure. A digital television playing system 100 includes a processing apparatus 110, a storage device 120 and a display screen 20. The display screen 20, for example, is a screen of a digital television set. The processing apparatus 110 may include a microprocessor, for example, an embedded microprocessor of the television. The storage device 120, for example, is a random access memory (RAM), a hard disk drive, or a solid state disk. In the present embodiment, the storage device 120 is a random access memory. The storage device 120 is configured for storing a plurality of program listings and program notes associated with the program listings that are arranged in a certain order, for example in the order of broadcast time. The processing apparatus 110 is configured for generating electronic program guide according to the program listings and the program notes stored in the storage device 120, and displaying the program listings and the program notes of the electronic program guide in the display screen 20. Specifically, the processing apparatus 110 includes an information fetching module 112, an electronic program guide generating module 114, a displaying module 116, and a program selecting module 118.

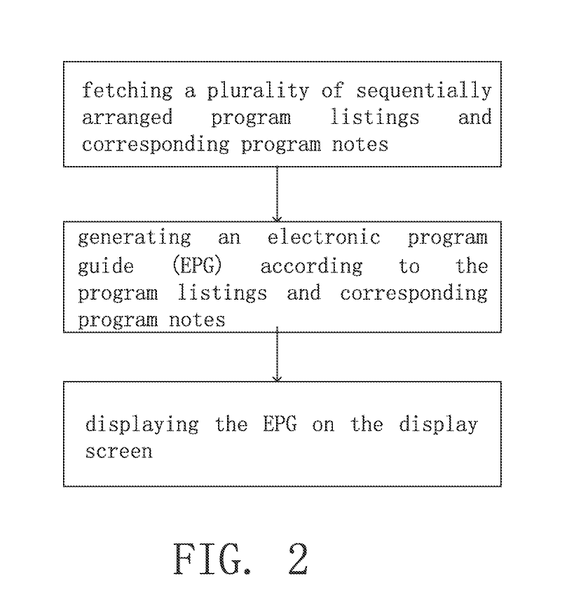

FIG. 2 is a flow chart of a method for displaying information associated with television program according to the present embodiment. The method is described with the processing apparatus 110 as follows. First, the information fetching module 112 fetches the program listings and the program notes associated with the program listings, and stores them in the storage device 120. Next, the electronic program guide generating module 114 generates an electronic program guide according to the program listings and the corresponding program notes stored in the storage device 120. Last, the displaying module 116 controls the display screen 20 to display the electronic program guide.

When the information fetching module 112 fetches the program listings and the program notes associated with the program listings, firstly, the currently selected or playing channel is obtained, then, program transport stream (TS) is locked according to the corresponding channel information. Program schedule and the corresponding introduction information could be read from the TS, and then converted into aforementioned program listings and the program notes of an appropriate format. The obtained program listings and the program notes are stored in the storage device 120. However, it is to be noted that, it is not limited to only use the above manner to obtain the program listings. For example, data (that describes the program listings) stored in an external storage device could be directly read, or downloaded via a network such as the internet. As it can provide accurate program listings, any methods could be applied into the present embodiment.

The program listings and the associated program notes are arranged in a certain order, for example, the time order. However, which order is used to store the program listings in the storage device 120 is not limited to be same with the certain order.

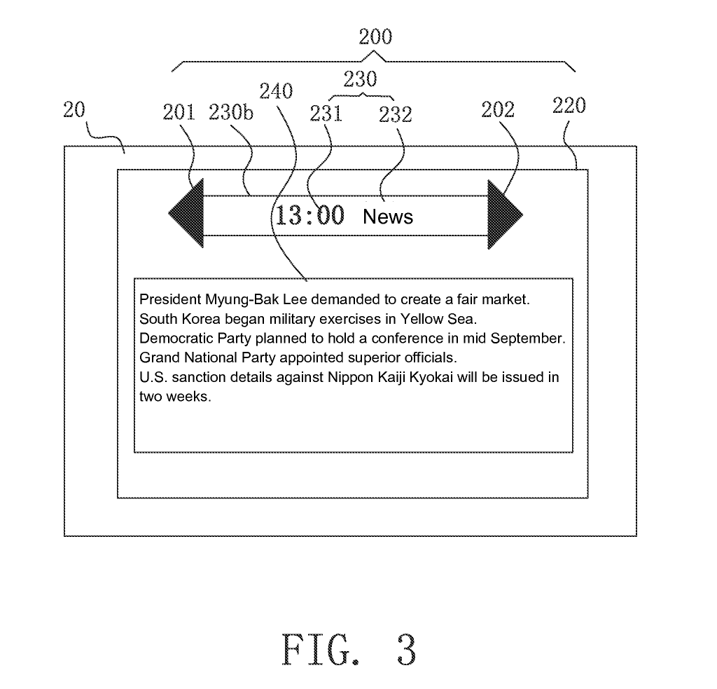

Please further refer to FIG. 3; it is a schematic view showing an architectural rendering of an electronic program guide 200 displayed in the display screen 20. The electronic program guide 200 includes a program listing 230, a program note 240, and at least one icon for indicating that the user would select to display the previous or the next program listing. The program note 240 is located below the program listing 230. The program listing 230 may include a broadcast time 231 and a program title 232. In the present embodiment, the program listing 230 only include the broadcast time 231 and the program title 232. The program note 240 may include the following information of the program corresponding to the currently selected program listing 230: the content introduction, the background of the program, the text of the program broadcast or the conversation, the interpretation of related terms in the program, the related photos, the screenshots or the video clip of the programs etc. According to the practical circumstance, the program note 240 may include a combination of the listed examples of the information. In the present embodiment, the program listing 230 is displayed in a program title area 230b of the screen 20. The program title area 230b can be rendered with a different color to highlight this area. Under a default circumstance, the program listing 230 is corresponding to the program played in the currently playing channel or the lastly watched channel before using the electronic program guide.

In the present embodiment, the at least one icon includes a first icon 201 and a second icon 202 displayed at two ends of the program title area 230b, respectively. In other words, the first icon 201 and the second icon 202 are displayed at two opposite sides of the program listing 230, respectively. The first icon 201 and the second icon 202 are used to indicate that the user would select to display the previous and the next program listing, respectively. The first icon 201 and the second icon 202 may include texts or images. For example, the first icon 201 is a left arrow, and the second icon 202 is a right arrow. In addition, if the displayed program listing is the first one of the plurality of program listings that is stored in the storage device 120 and arranged in a certain order, the processing apparatus 110 may further change a the status of the first icon 201 to indicate that there is no previous program listing before the current one. For example, the first icon 201 may be hided, or in other words, the first icon 201 is set to an invisible state. Also, the first icon 201 can be modified into a color that indicates it is unavailable such as grey. Moreover, the content of the first icon 201 can also be changed. If the displayed program listing is the last one of the plurality of program listings that is stored in the storage device 120 and arranged in a certain order, the processing apparatus 110 may further change a the status of the second icon 202 to indicate that there is no next program listing after the current one. For example, the second icon 202 may be hided, or in other words, the second icon 202 is set to an invisible state. Also, the second icon 202 can be modified into a color that indicates it is unavailable such as grey. Moreover, the content of the second icon 202 can also be changed.

The electronic program guide 200 may further include a background area 220, and the program listing 230 and the program note 240 are displayed in the background area 220. The background area 220 may partially or fully fills the display area of the screen 20. In addition, the background area 220 may be translucent or fully opaque. In the present embodiment, the background area 220 is fully opaque.

When the processing apparatus 110 receives a controlling instruction inputted by a user, for example, when a key of a set-top box or a remote controller is pressed, the program selecting module 118 of the processing apparatus 110 changes the program listing 230 and the corresponding program note 240 that are displayed on the screen 20. In detail, when the program selecting module 118 of the processing apparatus 110 receives an instruction for browsing the previous program listing, the program selecting module 118 of the processing apparatus 110 controls the display module 116 to display the previous program listing of the currently displayed program listing 230 that is displayed on the screen 20. Besides, to get a more intuitive visual effect, the status of the first icon 201 can be changed for a predetermined period. For example, the background color of the first icon 201 can be changed for the predetermined period such as 1 second; so that the user has the impression the key is accurately pressed. Moreover, it is not limited to only change the background color; other means such as displaying a short animation can also be employed. When the program selecting module 118 of the processing apparatus 110 receives an instruction for browsing the next program listing, the program selecting module 118 of the processing apparatus 110 controls the display module 116 to display the next program listing of the currently displayed program listing 230 that is displayed on the screen 20. Besides, to get a more intuitive visual effect, the status of the second icon 202 can be changed for a predetermined period. For example, the background color of the first icon 201 can be changed for the predetermined period such as 1 second; so that the user has the impression the key is accurately pressed. Moreover, it is not limited to only change the background color; other means such as displaying a short animation can also be employed.

In aforementioned method for displaying information associated with television program and the electronic program guide, because only one program listing 230 is displayed for each time, the occupied space is less, and the most space is available for displaying the program note 240. Thus, more information can be displayed, and the method has the advantages of intuitive, simple, and straightforward. In addition, the electronic program guide can also change the status of the icon according to the position of the currently displayed program listing in the list so that the interface is more intuitive and the user could get better using experience.

The above descriptions are only preferred embodiments of the present disclosure, and are not intended to by any limit to the present invention. Any one of ordinarily skilled in the art would made minor variations or modifications to the above described embodiments within the spirit of the present disclosure, and the obtained technical means are also included in the scope of the present invention.

What is claimed is:

1. A method for displaying information associated with television programs, comprising:
fetching a plurality of sequentially arranged program listings and corresponding program notes;
generating an electronic program guide according to the program listings and corresponding program notes; and
displaying the electronic program guide, wherein the electronic program guide comprises a program listing, a program note associated with the program listing, and at least one icon indicating that the user would select to display the previous or the next program listing in the electronic program guide.

2. The method of claim 1, wherein the at least one icon comprises a first icon and a second icon for indicating that the user would select to display the previous and the next program listing in the electronic program guide, respectively.

3. The method of claim 2, wherein the method further comprises changing the status of the first icon when the program listing is the first one, and changing the status of the second icon when the program listing is the last one.

4. The method of claim 3, wherein changing the status of the first icon or the second icon comprises setting the first icon or the second icon into invisible.

5. The method of claim 1, wherein the icon comprises texts or images.

6. The method of claim 1, wherein the method further comprises:
receiving inputting from user and displaying a previous or a next program listing and a related program note.

7. The method of claim 6, wherein displaying a previous or a next program listing further comprises:
changing the status of a corresponding icon of the at least one icon in a predetermined period.

8. The method of claim 1, wherein the plurality of program listings is arranged in the order of broadcast time.

9. The method of claim 1, wherein the program listing is displayed above the program note.

10. The method of claim 1, wherein the electronic program guide further comprises a background area, and the program listing and the program note are displayed on the background area.

11. The method of claim 10, wherein the background area is fully opaque.

12. The method of claim 1, wherein the electronic program guide only comprises one program listing.

13. An electronic program guide, comprising:
a program listing, comprising broadcast time and a program title;
a program note associated with the program listing; and
at least one icon indicating that the user would select to display the previous or the next program listing in the electronic program guide.

14. A processing apparatus, comprising:
an information fetching module, configured for fetching a plurality of sequentially arranged program listings and corresponding program notes;
an electronic program guide generating module, configured for generating an electronic program guide according to the program listings and corresponding program notes, wherein the electronic program guide comprises a program listing, a program note associated with the program listing, and at least one icon indicating that the user would select to display the previous or the next program listing in the electronic program guide; and
a displaying module, configured for displaying the electronic program guide on a screen.

15. The processing apparatus of claim 14, wherein the processing apparatus further comprise a program selecting module, configured for changing the program listing displayed in the electronic program guide and switching the program note in the electronic program guide according to the displayed program listing.
